(19) United States
(12) Patent Application Publication
(10) Pub. No.: US 2023/0352224 A1
(43) Pub. Date: Nov. 2, 2023

(54) MAGNETIC POWDER FOR MAGNETIC RECORDING MEDIUM, AND PRODUCTION METHOD THEREOF

(71) Applicants: DOWA ELECTRONICS MATERIALS CO., LTD., Tokyo (JP); FUJIFILM CORPORATION, Tokyo (JP)

(72) Inventors: Akifumi ONODERA, Tokyo (JP); Yasuto MIYAMOTO, Tokyo (JP); Masaki KOSHIKO, Tokyo (JP); Toshio TADA, Kanagawa (JP); Takashi FUJIMOTO, Kanagawa (JP)

(21) Appl. No.: 18/127,707

(22) Filed: Mar. 29, 2023

(30) Foreign Application Priority Data
Mar. 30, 2022 (JP) 2022-054709

(51) Int. Cl. H01F 1/34

(52) U.S. Cl. CPC H01F 1/348

(57) ABSTRACT

A magnetic powder for a magnetic recording medium includes magnetic particles in which Ba in hexagonal barium ferrite is partially substituted with Sr, wherein a Dx volume represented by Dx volume (nm³) = Dxc × π × (Dxa/2)² is 2,200 nm³ or less, and an Sr/(Ba+Sr) molar ratio is 0.01 to 0.15. One that satisfies Ku ≥ 0.1 × [Sr/(Ba+Sr) molar ratio] + 0.13 is more preferred. For the formulas, Dxc is a crystallite diameter (nm) in a c-axis direction of a hexagonal ferrite crystal lattice, Dxa is a crystallite diameter (nm) in an a-axis direction of the same crystal lattice, π is a circular constant, and Ku is a magnetocrystalline anisotropy constant (MJ/m³). By providing the hexagonal ferrite magnetic powder formed of fine particles, an effect of improving the perpendicular squareness ratio SQ of a magnetic recording medium is large.

### TECHNICAL FIELD

The present invention relates to a magnetoplumbite-type (M-type) hexagonal barium ferrite magnetic powder suitable for high-density recording on a magnetic recording medium, and a production method thereof.

### BACKGROUND ART

An M-type hexagonal ferrite magnetic powder is known as a magnetic powder suitable for high-density recording on a magnetic recording medium. M-type hexagonal ferrite has a basic structure represented by a chemical formula AO·6Fe₂O₃ . The element A in the chemical formula is Ba, Sr, Pb, Ca, or the like. As the M-type hexagonal ferrite for a magnetic recording medium, barium ferrite in which most of the element A is Ba or strontium ferrite in which most of the element A is Sr is generally used. Fe sites are sometimes partially substituted with a metal element such as Co, Zn, Ti, Sn, Nb, or V according to the required properties.

PTL 1 describes a hexagonal barium ferrite magnetic powder having a composition in which Fe sites are partially substituted with predetermined amounts of Ti, Zn, and Co. It is said that this improves the temperature stability of the coercivity (coercive force). It is said that as the element A, Ba and Sr may be used in combination, and in Example 7, an Sr-containing hexagonal barium ferrite magnetic powder in which an Sr/(Ba+Sr) molar ratio is 0.08 is shown.

On the other hand, it is known that hexagonal strontium ferrite has a high magnetocrystalline anisotropy constant Ku and is advantageous in enhancing the thermal stability of magnetization.

PTLs 2 and 3 describe a hexagonal strontium ferrite magnetic powder refined by incorporating Ba. Most of the element A is Sr, and the Sr/(Ba+Sr) molar ratio of the magnetic powder disclosed in PTLs 2 and 3 is about 0.5 to 0.95.

### CITATION LIST

### Patent Literature

PTL 1] JPS63-234409A
PTL 2] JP2015-127984A
PTL 3] JP2015-127985A

### SUMMARY OF INVENTION

### Techinical Problem

In order to improve the performance of a magnetic recording medium, it is important to improve both the recording density and the SNR (S/N ratio). From the viewpoint of improving the recording density, refinement of magnetic particles (specifically, reduction in Dx volume) is advantageous. On the other hand, it has been confirmed that the SNR (S/N ratio) of a magnetic recording medium greatly depends on the perpendicular squareness ratio SQ as a medium property. Improvement in the perpendicular squareness ratio SQ is effective in improving the SNR. The perpendicular squareness ratio SQ is a squareness ratio in a magnetization curve when a magnetic field is applied in a direction perpendicular to a magnetic layer.

In the hexagonal strontium ferrite as disclosed in PTLs 2 and 3, the tabular ratio represented by the ratio (Dxa/Dxc) of the crystallite diameter Dxa in the a-axis direction and the crystallite diameter Dxc in the c-axis direction of the crystal lattice tends to be small, and the property (orientation) in which the c-axis is aligned in the direction perpendicular to the magnetic layer as much as possible is poor, and therefore, it is disadvantageous when a high reproduction output is intended to be exhibited by a magnetic recording medium having a particularly thin magnetic layer. On the other hand, hexagonal barium ferrite is advantageous in that magnetic particles having a large tabular ratio are easy to obtain. However, hexagonal barium ferrite has a smaller magnetocrystalline anisotropy constant Ku than hexagonal strontium ferrite, and approaches superparamagnetism when formed into fine particles, and therefore, the perpendicular squareness ratio SQ is lowered. There is no established method for realizing a hexagonal barium ferrite fine particle magnetic powder having an excellent effect of improving the perpendicular squareness ratio SQ of a magnetic recording medium. PTL 1 illustrates an Sr-containing hexagonal barium ferrite magnetic powder (Example 7), but it is synthesized by a production method of directly firing raw material mixed substances without going through an amorphous body, and therefore, the particle diameter is large (0.17 µm is shown in Example 7 in Table 2), and it cannot be applied to the use for recent high-density recording. Moreover, PTL 1 does not suggest improvement in the perpendicular squareness ratio SQ of a magnetic recording medium.

An object of the invention is to provide a hexagonal ferrite magnetic powder formed of fine particles, wherein an effect of improving the perpendicular squareness ratio SQ of a magnetic recording medium is large.

### Solution to Problem

As a result of studies, the inventors found that in a hexagonal barium ferrite magnetic powder having a specific composition range containing a small amount of Sr as the element A, an effect of improving the perpendicular squareness ratio SQ of a magnetic recording medium is brought about. That is, when the Sr content is too high, the tabular ratio of the hexagonal particles becomes small, and the orientation of the magnetic particles in the magnetic recording medium deteriorates, so that the perpendicular squareness ratio SQ of a magnetic recording medium is lowered. In addition, they found that by applying a process in which a preliminary heat treatment is performed for an amorphous body obtained by quenching a melt of raw material substances, and then, the resultant is crystallized by firing, it is possible to obtain a magnetic powder in which the relationship between the magnetocrystalline anisotropy constant Ku (MJ/m³) and the Sr/(Ba+Sr) molar ratio is within a predetermined range can be obtained, and in the magnetic powder, the composition range in which the effect of improving the perpendicular squareness ratio SQ of a magnetic recording medium is brought about is expanded. The invention is based on these findings.

The above object is achieved by the following inventions.

A magnetic powder for a magnetic recording medium, including magnetic particles in which Ba in hexagonal barium ferrite is partially substituted with Sr, wherein a Dx volume represented by the following formula (1) is 2,200 nm³ or less, and an Sr/(Ba+Sr) molar ratio is 0.01 to 0.15:

$$\text{Dx volume} \left({\text{nm}}^{3}\right) = \text{Dxc} \times π \times {\left(\text{Dxa} / 2\right)}^{2} \qquad \text{(1)}$$

wherein Dxc is a crystallite diameter (nm) in a c-axis direction of a hexagonal ferrite crystal lattice, Dxa is a crystallite diameter (nm) in an a-axis direction of the same crystal lattice, and n is a circular constant.

A magnetic powder for a magnetic recording medium, including magnetic particles in which Ba in hexagonal barium ferrite is partially substituted with Sr, wherein a Dx volume represented by the following formula (1) is 2,200 nm³ or less, an Sr/(Ba+Sr) molar ratio is 0.01 to 0.30, and a relationship between a magnetocrystalline anisotropy constant Ku (MJ/m³) and the Sr/(Ba+Sr) molar ratio satisfies the following formula (2):

$$\text{Dx volume} \left({\text{nm}}^{3}\right) = \text{Dxc} \times π \times {\left(\text{Dxa} / 2\right)}^{2} \qquad \text{(1)}$$

wherein Dxc is a crystallite diameter (nm) in a c-axis direction of a hexagonal ferrite crystal lattice, Dxa is a crystallite diameter (nm) in an a-axis direction of the same crystal lattice, and n is a circular constant, and

$$\text{Ku} \geq \text{0} \text{.1} \times \left[\text{Sr} / \left(\text{Ba+Sr}\right) \text{molar ratio}\right] + 0.13 \qquad \text{(2)}$$

The magnetic powder for a magnetic recording medium according to the above [2], wherein the Sr/(Ba+Sr) molar ratio is 0.01 to 0.15.

The magnetic powder for a magnetic recording medium according to any one of the above [1] to [3], wherein Bi is contained such that a Bi/Fe molar ratio is within a range of 0.005 to 0.05.

A production method of the magnetic powder for a magnetic recording medium according to the above [1], including a step of crystallizing an amorphous body containing Sr as a constituent element of hexagonal barium ferrite by heating within a temperature range of 600 to 670° C.

A production method of the magnetic powder for a magnetic recording medium according to the above [2], including:
a step of obtaining an intermediate by holding an amorphous body containing Sr as a constituent element of hexagonal barium ferrite at a temperature of 500 to 570° C. for 10 hours or more; and
a step of crystallizing the intermediate by heating within a temperature range of 600 to 670° C.

### (Advantageous Effects of Invention]

According to the invention, a hexagonal ferrite magnetic powder formed of fine particles, wherein an effect of improving the perpendicular squareness ratio SQ of a magnetic recording medium is large, can be achieved. Therefore, the invention can contribute to both improvement in the recording density and improvement in the SNR of a magnetic recording medium at high levels.

### BRIEF DESCRIPTION OF DRAWINGS

FIG. 1 is a graph showing a relationship between an Sr/(Sr+Ba) molar ratio of a hexagonal barium ferrite magnetic powder and a perpendicular squareness ratio SQ of a magnetic tape using the magnetic powder.

FIG. 2 is a graph showing a relationship between an Sr/(Sr+Ba) molar ratio and a magnetocrystalline anisotropy constant Ku of a hexagonal barium ferrite magnetic powder.

### DESCRIPTION OF EMBODIMENTS

Hereinafter, matters specifying the invention will be described.

### Dx Volume

In order to improve the recording density of a magnetic recording medium, it is advantageous that hexagonal ferrite crystal grains are fine. As a size parameter of crystal grains, a Dx volume obtained from a crystallite diameter can be adopted. The Dx volume is calculated according to the following formula (1).

$$\text{Dx volume} \left({\text{nm}}^{3}\right) = \text{Dxc} \times π \times {\left(\text{Dxa} / 2\right)}^{2} \qquad \text{(1)}$$

Here, Dxc is a crystallite diameter (nm) in a c-axis direction of a hexagonal ferrite crystal lattice, Dxa is a crystallite diameter (nm) in an a-axis direction of the same crystal lattice, and n is a circular constant. The crystallite diameter can be obtained from the half width of a diffraction peak measured by X-ray diffractometry (XRD) using a Cu-Kα ray as shown in Examples below.

According to studies by the inventors, in order to obtain a magnetic recording medium having a sufficiently high recording density, it is desirable to use a hexagonal barium ferrite magnetic powder having a Dx volume of 2,200 nm³ or less. The Dx volume is more preferably 2,000 nm³ or less. In an application where great importance is attached in particular to the improvement in the recording density, it is advantageous that the Dx volume is adjusted to 1,800 nm³ or less, and it can also be adjusted to 1,750 nm³ or less. On the other hand, when the Dx volume is adjusted within a relatively high range, a higher value is likely to be achieved for the perpendicular squareness ratio SQ of the magnetic recording medium. In an application where great importance is attached in particular to the improvement in the perpendicular squareness ratio SQ of the magnetic recording medium, that is, the improvement in the SNR of the magnetic recording medium, it is advantageous that the Dx volume is adjusted, for example, within a range greater than 1,800 nm³ and 2,200 nm³ or less, and it may be adjusted within a range greater than 1,800 nm³ and 2,000 nm³ or less. The Dx volume can be controlled by a firing temperature for crystallization or heat history before firing in a process for synthesizing a hexagonal ferrite crystal through a process for amorphizing the melt of the raw material substances. In order to significantly reduce the Dx volume, it is necessary to considerably lower the firing temperature, and in that case, there is a concern that the magnetic properties may deteriorate due to the deterioration of the crystallinity. Normally, the Dx volume may be adjusted within a range of 1,100 nm³ or more, and may be controlled to 1,300 nm³ or more.

### Composition

By partially substituting Ba in hexagonal barium ferrite with a small amount of Sr, a magnetic powder in which the effect of improving the perpendicular squareness ratio SQ of the magnetic recording medium (hereinafter, this is sometimes referred to as the “medium SQ improvement effect”) is large can be achieved. Specifically, by setting the Sr/(Ba+Sr) molar ratio within a range of 0.01 to 0.15, the medium SQ improvement effect can be obtained. It is more effective to set the Sr/(Ba+Sr) molar ratio within a range of 0.03 to 0.15, more preferably within a range of 0.05 to 0.15. The “Sr/(Ba+Sr) molar ratio” means the ratio of the number of moles of Sr to the total number of moles of Ba and Sr that form hexagonal ferrite. When the Sr/(Ba+Sr) molar ratio becomes large exceeding 0.15, the medium SQ improvement effect tends to decrease, and sometimes becomes worse than when no Sr is added. Although the mechanism has not been elucidated, it is presumed that as the substitution ratio with Sr increases, an increase in the coercive force Hc due to an increase in the magnetocrystalline anisotropy constant Ku positively acts on the medium SQ improvement effect, but a decrease in the orientation of the magnetic particles in the magnetic layer due to a decrease in the tabular ratio (Dxa/Dxc) of the magnetic particles negatively acts on the medium SQ improvement effect, and the range of the Sr/(Ba+Sr) molar ratio in which the medium SQ improvement effect is effectively exhibited is generated by the balance between them.

On the other hand, when using a hexagonal barium ferrite magnetic powder obtained by a production method (described later) that has a large effect of improving the magnetocrystalline anisotropy constant Ku, it becomes possible to expand the range of the Sr/(Ba+Sr) molar ratio in which the medium SQ improvement effect is exhibited. Specifically, in a hexagonal barium ferrite magnetic powder in which the relationship between the magnetocrystalline anisotropy constant Ku (MJ/m³) and the Sr/(Ba+Sr) molar ratio satisfies the following formula (2), the medium SQ improvement effect can be obtained when the Sr/ (Ba+Sr) molar ratio is within a range of 0.01 to 0.30. It is more effective that the Sr/(Ba+Sr) molar ratio is within a range of 0.03 to 0.30, more preferably within a range of 0.05 to 0.30.

$$\text{Ku} \geq \text{0} \text{.1} \times \left[\text{Sr} / \left(\text{Ba+Sr}\right) \text{molar ratio}\right] + 0.13 \qquad \text{(2)}$$

As for the Fe site of hexagonal barium ferrite, part of Fe may be substituted with one or more divalent, tetravalent, or pentavalent metal elements. Examples of the divalent metal element include Co and Zn, examples of the tetravalent metal element include Ti and Sn, and examples of the pentavalent metal element include Nb and V. As for the Fe site substituting element, it is preferred to set the [total content of Fe site substituting element (mol)]/[Fe content (mol)] to 0.001 to 0.060.

The hexagonal barium ferrite magnetic powder targeted by the invention may contain Bi. Bi is not an element that forms the crystal structure of hexagonal ferrite (an element that enters any of the atomic sites of the chemical formula AO-6Fe₂O₃), but is an effective additive element for refining hexagonal ferrite crystal grains and improving the electromagnetic conversion characteristics of a magnetic recording medium using the magnetic powder. In particular, it has the effect of reducing the deterioration of the magnetic properties even when aiming at refinement of the crystal grains by lowering the firing temperature. When Bi is contained, it is effective to set the Bi/Fe molar ratio within a range of 0.005 to 0.05.

Moreover, one or more rare earth elements such as Nd, Y, Sm, Er, and Ho, or Al may be contained according to required properties. These elements also do not form the crystal structure of hexagonal ferrite. In the case where one or more rare earth elements are contained, when the rare earth element is represented by R, it is preferred to set the R/Fe molar ratio to 0.001 to 0.010. When Al is contained, it is preferred to set the Al/Fe molar ratio to 0.001 to 0.050.

### [Production Method]

As a production method of a hexagonal barium ferrite magnetic powder, from the viewpoint of obtaining a hexagonal ferrite magnetic powder having a uniform grain size distribution with a small crystal grain size, it is preferred to apply a process going through an amorphous body obtained by quenching the melt of the raw material substances. Examples of the process include the following two patterns.

### (Pattern 1)

A pattern in which the above-mentioned amorphous body is crystallized by firing. This is a so-called “glass crystallization method”, and a conventionally known method can be used. Specifically, a step of crystallizing an amorphous body containing Sr as a constituent element of hexagonal barium ferrite by heating within a temperature range of 600 to 670° C. can be applied. This “pattern 1” can be used for the synthesis of a hexagonal barium ferrite magnetic powder in which the Sr/(Ba+Sr) molar ratio is within a composition range of 0.01 to 0.15, and the medium SQ improvement effect can be obtained within the composition range.

### (Pattern 2)

A pattern in which the above-mentioned amorphous body is subjected to a preliminary heat treatment and thereafter crystallized by firing. This is a new method disclosed in the present specification. Specifically, a process including a step of obtaining an intermediate by holding an amorphous body containing Sr as a constituent element of hexagonal barium ferrite at a temperature of 500 to 570° C. for 10 hours or more, and a step of crystallizing the intermediate by heating within a temperature range of 600 to 670° C. can be applied. In the preliminary heat treatment for obtaining the intermediate, it is considered that most of the divalent Fe contained in the amorphous body obtained by quenching is oxidized to trivalent Fe. It is considered that by using the intermediate in a state where trivalent Fe is formed in advance, the reaction for allowing oxidation of divalent Fe to trivalent Fe to proceed during firing can be greatly reduced. As a result, a hexagonal barium ferrite magnetic powder having an improved magnetocrystalline anisotropy constant Ku is synthesized. This “pattern 2” can be used for the synthesis of a hexagonal barium ferrite magnetic powder in which the Sr/(Ba+Sr) molar ratio is within a composition range of 0.01 to 0.30, and the medium SQ improvement effect can be obtained within the composition range. The method of pattern 2 expands the composition range of the Sr/(Ba+Sr) molar ratio in which the medium SQ improvement effect is exhibited, and is also extremely effective in increasing the medium SQ improvement effect itself.

### EXAMPLES

### Example 1

### (Production of Hexagonal Barium Ferrite Magnetic Powder)

Boric acid H₃BO₃ (for industrial use), barium carbonate BaCO₃ (for industrial use), strontium carbonate SrCO₃ (for industrial use), iron oxide Fe₂O₃ (for industrial use), cobalt oxide CoO (reagent, purity: 90% or more), titanium oxide TiO₂ (reagent first grade), bismuth oxide Bi₂O₃ (for industrial use), neodymium oxide Nd₂O₃ (for industrial use), and aluminum hydroxide Al(OH)₃ (reagent, purity: 99.0% or more) were weighed to obtain a raw material composition shown in Table 1, and mixed using an FM mixer manufactured by Mitsui Miike Machinery Co., Ltd., thereby obtaining a raw material mixture. The raw material mixture was placed in a pelletizer and granulated by forming into a spherical shape while spraying water, and then dried at 270° C. for 14 hours, thereby obtaining a granulated product with a particle diameter of 1 to 50 mm.

The granulated product was melted in a melting furnace using a platinum crucible. After raising the temperature to 1400° C. and holding the product for 60 minutes while stirring, each raw material substance was brought to a completely molten state, and then, the molten material was discharged from a nozzle and quenched by a gas atomization method, thereby obtaining an amorphous body.

The obtained amorphous body was crystallized by applying the process (pattern 2 described above) of sequentially performing the following heat treatments.

### <Preliminary Heat Treatment>

An intermediate was obtained by heating and holding the above amorphous body in air at 530° C. for 72 hours.

### <Crystallization Heat Treatment>

The obtained intermediate was crystallized by heating and holding in air at 630° C. for 60 minutes.

The powder obtained by the crystallization heat treatment contains a residual substance mainly containing barium borate other than hexagonal ferrite. In order to remove the residual substance, acid washing was performed such that the powder obtained by the crystallization heat treatment was immersed in a 10 mass% aqueous acetic acid solution heated to 60° C. and held for 1 hour with stirring to dissolve the residual substance in the solution, and thereafter, solid-liquid separation was performed by filtration, and pure water was added for washing. Pure water was added to the obtained solid material, and the resultant was stirred and wet pulverized with a star mill.

An aqueous aluminum chloride solution was added to the slurry containing the solid material after wet pulverization. The addition amount of Al due to aluminum chloride was 3.3 parts by mass in terms of Al(OH)₃ with respect to 100 parts by mass of the solid material. The slurry after adding the aqueous aluminum chloride solution was stirred at 40° C. for 10 minutes. The pH of this slurry was within a range of 3.0 to 4.0. Thereafter, sodium hydroxide was added to adjust the pH to 8.0 to 9.0, and the resultant was further stirred at 40° C. for 10 minutes, thereby forming a layer of aluminum hydroxide, which is a reaction product, on the surfaces of particles of the solid material (hexagonal ferrite magnetic particles). Thereafter, solid-liquid separation was performed by filtration, pure water was added thereto, and washing with water was performed until the electrical conductivity of the liquid after washing (filtrate) became 10 uS/cm or less. After washing with water, the resultant was dried in air at 110° C. for 12 hours. Thus, a dry powder in which aluminum hydroxide was coated on the surfaces of the hexagonal barium ferrite particles was obtained. This aluminum hydroxide contributes to improvement in the durability of a magnetic recording medium.

As a finish pulverization step, the obtained dry powder was put into an impact mill (Fine Impact Mill AVIS-150, manufactured by Millsystem Co., Ltd.) at a feed rate of 150 g/min, and pulverized at a rotational speed of 9750 rpm with a distance of 1 mm between the pin tip of the rotor of the impact mill and the base of the stator. The pulverization conditions were set within the range of appropriate conditions obtained by a preliminary experiment. The hexagonal barium ferrite magnetic powder having undergone the finish pulverization step was used as a test powder in the following studies. The main items of the magnetic powder production conditions are shown in Table 1.

### (Composition Analysis of Magnetic Powder)

The composition of the test powder was analyzed using a high-frequency inductively coupled plasma atomic emission spectrometer ICP (720-ES) manufactured by Agilent Technologies, Inc. The analysis was performed by setting the measurement wavelength (nm) as follows: Fe: 259.940 nm, Ba: 233.527 nm, Sr: 421.552 nm, Co: 231.160 nm, Ti: 334.941 nm, Bi: 222.821 nm, Nd: 406.108 nm, and Al: 396.152 nm. The measurement wavelength of each metal element was selected according to the composition of the magnetic powder to be analyzed so that there is no spectral interference with other elements and the linearity of the calibration curve can be obtained. From the obtained quantitative values, the molar ratio of each element to Fe was calculated. The X/Fe molar ratio for a certain element X (X is, for example, Co, Al, or the like) is calculated according to the following formula.

$$\text{X} / \text{Fe molar ratio = X content} \left(\text{mol\%}\right) / \text{Fe content} \left(\text{mol\%}\right)$$

The content of Ba was indicated by a Ba/Fe site element molar ratio calculated according to the following formula.

$$\begin{matrix}\text{Ba} / \text{Fe} \text{site element molar ratio = Ba content} \\ \left(\text{mol\%}\right) / \text{total content} \text{of Fe and transition metal elements} \\ \text{partially substituting Fe sites} \left(\text{mol\%}\right)\end{matrix}$$

In this example, the transition metal elements partially substituting Fe sites are only Co and Ti, and therefore, the formula becomes as follows: Ba/Fe site element molar ratio = Ba content (mol%)/(Fe content (mol%) + Co content (mol%) + Ti content (mol%)).

The content of Sr was indicated by an Sr/(Sr+Ba) molar ratio. The Sr/(Sr+Ba) molar ratio of the test powder of this example was 0.041.

### (Measurement of Powder Magnetic Properties)

The test powder was packed in a φ 6 mm plastic container, and by using a vibrating sample magnetometer (VSM-P7-15, manufactured by Toei Industry Co., Ltd.), a coercive force Hc, a saturation magnetization os, and a squareness ratio SQ were measured under the following conditions: external magnetic field: 795.8 kA/m (10 kOe), M measurement range: 0.010 A•m² (10 emu), step bit: 198 (bit), time constant: 0.03 sec, and wait time 0.1 sec.

### (Measurement of BET Specific Surface Area)

With respect to the test powder, a specific surface area was obtained by a BET single point method using a full automatic specific surface area analyzer (Macsorb HM Model-1210, manufactured by Mountech Co., Ltd.).

### (Evaluation of Activation Volume Vact and Magnetocrystalline Anisotropy Constant Ku)

A pulse magnetic field generator (TP15326, manufactured by TESLA) and a vibrating sample magnetometer (VSM-5, manufactured by Toei Industry Co., Ltd.) were used. An activation volume Vact and a magnetocrystalline anisotropy constant Ku were evaluated by the following operations (1) to (10). However, the operations (2) to (10) were performed at 25 ± 1° C. The amount of residual magnetization was measured by setting the M measurement range to 0.005 A·m² (5 emu) and the time constant to 0.03 sec.

The hexagonal barium ferrite magnetic powder to be tested was packed in a _{φ} 6 mm plastic container.

A magnetic field of 1034.54 kA/m (13 kOe) was applied by a vibrating sample magnetometer to saturate the magnetization, and the magnetic field was returned to zero. At this time, the step bit was set to 240 bits, the wait time was set to 0.8 sec, and the magnetic field was applied in the return mode.

The sample was detached from the vibrating sample magnetometer and attached to a pulse magnetic field generator. At this time, the sample was attached so that a magnetic field (referred to as a reverse magnetic field) was applied in a direction opposite to the direction of saturation magnetization.

A magnetic field was applied for a reverse magnetic field application time of 0.40 ms, and the magnetic field was returned to zero. The applied magnetic field is Hc + 23.88 kA/m as a standard in the first time. In the second time and thereafter, a reverse magnetic field different from that in the first time is set with reference to the result in the first time so that the residual magnetization is close to zero.

The sample was detached from the pulse magnetic field generator and attached to the vibrating sample magnetometer so that the direction of the sample is the same as in (2).

The amount of residual magnetization was measured with the vibrating sample magnetometer. The operation from the end of the operation (2) to the measurement of the residual magnetization was performed in 20 seconds.

The value of the reverse magnetic field applied in (4) was changed, and the operations (2) to (6) were further repeated four times or more.

Five or more measurement results were selected and linearly approximated so as to obtain the reverse magnetic field value Hr (0.40 ms) at which the residual magnetization is 0 Am²/kg by interpolation, and the operations (2) to (7) were repeated until the value of the coefficient of determination R² reached 0.990 or more. From this approximate straight line, the reverse magnetic field value Hr (0.40 ms) when the residual magnetization is 0 Am²/kg was obtained. This Hr is called a residual coercive force. The value of the reverse magnetic field to be applied can be appropriately set according to the Hr value of the magnetic body.

The reverse magnetic field application time was set to 6.1 ms, and the same operations as (2) to (8) were performed, and then, a residual coercive force Hr (6.1 ms) when the residual magnetization was 0 Am²/kg was obtained.

The reverse magnetic field application time was changed to 17 s and the apparatus for applying a magnetic field was changed to a vibrating sample magnetometer, and the same operations as (2) to (8) were performed, and then, a residual coercive force Hr (17 s) when the residual magnetization was 0 Am²/kg was obtained. At this time, the operations of attaching and detaching the sample in (3) to (5) were not performed. In addition, the number of repetitions in (7) was set to 2 or more, and in (8), three measurement results were selected and linearly approximated, and the value of determination coefficient R² was set to 0.997 or more.

Hr (0.40 ms), Hr (6.1 ms), and Hr (17 s) were analyzed using data analysis software (Origin, manufactured by OriginLab Corporation). The Curve Fit (non-linear) function was used, H₀ and KuV/kT in the following formula (3) were used as the fitting parameters, and optimization was performed by the least squares method, thereby obtaining the values of H₀ and KuV/kT. At this time, 5000 and 50 were input as the initial values of H₀ and KuV/kT, respectively. The activation volume Vact was calculated by substituting H₀ and KuV/kT obtained by the least squares method into the following formula (4). Further, the magnetocrystalline anisotropy constant Ku was calculated by substituting H₀ into the following formula (5).

$$\text{Hr} \left(\text{t}\right) = {\text{H}}_{0} \left\{1 - {\left[\left(\text{kT} / \text{KuV}\right) ln \left({\text{f}}_{0} \text{t} / ln 2\right)\right]}^{0.77}\right\} \qquad \text{(3)}$$

Here, k is a Boltzmann constant (J/K), T is a measurement temperature (K), Ku is a magnetocrystalline anisotropy constant (J/m³), V = Vact is an activation volume (nm³), Hr(t) is a residual coercive force (kA/m) at a reverse magnetic field application time t, H₀ is a residual coercive force (kA/m) in 10⁻⁹ seconds, f₀ is a spin precession frequency (s⁻¹), and t is a reverse magnetic field application time (s). The value of f₀ is 10⁹ (s⁻¹) here.

$$\text{Vact} \left({\text{nm}}^{3}\right) = 1.249 \times {10}^{4} \times \text{KuV} / \text{kT} / {\text{H}}_{0} \qquad \text{(4)}$$

$$\text{Ku} \left(\text{J} / {\text{m}}^{3}\right) = 331 \times {\text{H}}_{0} \left(\text{kA} / \text{m}\right) \qquad \text{(5)}$$

Here, the coefficient 1.249 × 10⁴ in the formula (4) and the coefficient 331 in the formula (5) are sums of individual numerical values and unit conversion coefficients in the calculation process.

When the unit of the Ku value calculated according to the above formula (5) was converted to MJ/m³, the magnetocrystalline anisotropy constant Ku of the test powder of this example was obtained as 0.139 MJ/m³.

### (Evaluation of Dx Volume and Dx Ratio)

By an X-ray diffractometer (Ultima IV, manufactured by Rigaku Corporation) using a Cu tube, the crystallite diameter Dxc (nm) in the c-axis direction and the crystallite diameter Dxa (nm) in the a-axis direction of the hexagonal ferrite crystal lattice were obtained according to the following formula (6).

$$\text{Crystallite diameter} \left(\text{nm}\right) = \text{K} λ / \left(β ⋅ cos θ\right) \qquad \text{(6)}$$

Here, K is a Scherrer constant 0.9, λ is a Cu-Kα ray wavelength (nm), β is a half width (radian) of a diffraction peak of a hexagonal crystal (006) plane in the measurement of Dxc, and a half width (radian) of a diffraction peak of a hexagonal crystal (220) plane in the measurement of Dxa, and θ is a Bragg angle of a diffraction peak (½ of diffraction angle 2θ) (radian).

Dxc was measured by scanning a 2θ range from 20.5 to 25°, and Dxa was measured by scanning a 2θ range from 60 to 65°. The measurement method was a continuous measurement method of a concentration method, and a one-dimensional semiconductor detector (D-tex) was used as the detector. The measurement was performed with a divergence slit of ½°, a scattering slit of 8 mm, and a receiving slit open. The sampling interval was set as follows: Dxc: 0.05°, Dxa: 0.02°, the scanning speed was set as follows: Dxc: 0.1°/min, Dxa: 0.4°/min, and the integration frequency was set to once.

The Dx volume and the Dx ratio (tabular ratio) were each calculated by substituting the measured values of Dxc (nm) and Dxa (nm) into the following formula (1) and formula (7) .

$$\text{Dx volume} \left({\text{nm}}^{3}\right) = \text{Dxc} \times π \times {\left(\text{Dxa} / 2\right)}^{2} \qquad \text{(1)}$$

$$\text{Dx ratio =} \text{Dxa} / \text{Dxc} \qquad \text{(7)}$$

Here, n is a circular constant.

By using the above-mentioned test powder (hexagonal barium ferrite magnetic powder), a magnetic recording medium (magnetic tape) was produced as follows. “Parts” and “%” described with respect to the production of the magnetic tape mean “parts by mass” and “mass%”, respectively, unless otherwise specified.

### (Formulation of Magnetic Layer Coating Liquid)

### <Magnetic Liquid>

Hexagonal barium ferrite magnetic powder particles: 100.0 parts
Oleic acid: 1.5 parts
Vinyl chloride copolymer (MR-104, manufactured by Zeon Corporation): 8.0 parts
SO₃Na group-containing polyurethane resin (weight average molecular weight: 70,000, SO₃Na group: 0.07 meq/g): 2.0 parts
Amine-based polymer (DISPERBYK-102 manufactured by BYK-Chemie GmbH): 7.0 parts
Methyl ethyl ketone: 150.0 parts
Cyclohexanone: 150.0 parts

### <Abrasive Liquid>

α-alumina (specific surface area: 19 m²/g, sphericity: 1.4): 6.0 parts
SO₃Na group-containing polyurethane resin (weight average molecular weight: 70,000, SO₃Na group: 0.1 meq/g): 0.6 parts
2,3-dihydroxynaphthalene: 0.6 parts
Cyclohexanone: 23.0 parts

### Non-Magnetic Filler Liquid

Colloidal silica (average particle size: 80 nm, coefficient of variation = 7%, sphericity: 1.03): 2.0 parts
Methyl ethyl ketone: 8.0 parts

### Lubricant/Curing Agent Liquid

Stearic acid: 3.0 parts
Stearic acid amide: 0.3 parts
Butyl stearate: 6.0 parts
Methyl ethyl ketone: 110.0 parts
Cyclohexanone: 110.0 parts
Polyisocyanate (Coronate (registered trademark) L, manufactured by Nippon Polyurethane Industry Co., Ltd.): 3 parts

### Formulation of Non-Magnetic Layer Coating Liquid

Non-magnetic powder α-iron oxide (average major axis length: 10 nm, average acicular ratio: 1.9, BET specific surface area: 75 m²/g): 100 parts
Carbon black (average particle diameter: 20 nm): 25 parts
SO₃Na group-containing polyurethane resin (average molecular weight: 70,000, SO₃Na group content: 0.2 meq/g): 18 parts
Stearic acid: 1 part
Cyclohexanone: 300 parts
Methyl ethyl ketone: 300 parts

### (Formulation of Backcoat Layer Coatin Liquid)

Non-magnetic inorganic powder: α-iron oxide (average major axis length: 0.15 µm, average acicular ratio: 7, BET specific surface area: 52 m²/g): 80 parts
Carbon black (average particle diameter: 20 nm): 20 parts
Vinyl chloride copolymer: 13 parts
Sulfonate base-containing polyurethane resin: 6 parts
Phenylphosphonic acid: 3 parts
Cyclohexanone: 155 parts
Methyl ethyl ketone: 155 parts
Stearic acid: 3 parts
Butyl stearate: 3 parts
Polyisocyanate: 5 parts
Cyclohexanone: 200 parts

### (Production of Magnetic Tape)

The magnetic layer coating liquid was prepared by dispersing each substance according to the formulation of the magnetic layer coating liquid described above for 24 hours using 0.1 mm φ zirconia beads in a batch-type vertical sand mill (bead dispersion), followed by filtration using a filter having an average pore diameter of 0.5 µm.

The non-magnetic layer coating liquid was prepared by dispersing each substance according to the formulation of the non-magnetic layer coating liquid described above for 24 hours using 0.1 mm zirconia beads in a batch-type vertical sand mill (bead dispersion), followed by filtration using a filter having an average pore diameter of 0.5 µm.

The backcoat layer coating liquid was prepared by kneading and diluting each substance excluding the lubricants (stearic acid and butyl stearate), polyisocyanate, and 200 parts of cyclohexanone from the substances shown in the formulation of the backcoat layer coating liquid described above using an open-type kneader, and thereafter subjecting the resultant to 12 passes of dispersion treatment in a horizontal bead mill dispersing machine using 1 mm zirconia beads by setting the bead filling rate to 80%, the rotor tip peripheral speed to 10 m/s, and the residence time per pass to 2 minutes, and then, adding the rest of the substances and stirring with a dissolver, and filtering the obtained dispersion liquid using a filter having an average pore diameter of 1 µm.

The non-magnetic layer coating liquid prepared above was applied onto the surface of a polyethylene naphthalate support having a thickness of 5 µm (Young’s modulus in transverse direction: 8 GPa, Young’s modulus in longitudinal direction: 6 GPa) so that the thickness after drying would be 100 nm, followed by drying, and then, the magnetic layer coating liquid prepared above was applied thereon so that the thickness after drying would be 70 nm. While this magnetic layer coating liquid was in an undried state, a vertical alignment treatment in which a magnetic field having a magnetic field strength of 0.3 T is applied in a direction perpendicular to the coating surface was performed, and then, the resultant was dried. Thereafter, the backcoat layer coating liquid prepared above was applied to the surface on the opposite side of the support so that the thickness after drying would be 0.4 µm, followed by drying. The resulting tape was subjected to a surface smoothing treatment by a calender formed only of a metal roll at a speed of 100 m/min, a linear pressure of 300 kg/cm, and a temperature of 100° C., and then subjected to a heat treatment for 36 hours in a dry environment at 70° C. After the heat treatment, the resultant was slit to a width of ½ inch, thereby obtaining a magnetic tape.

### (Evaluation of Perpendicular Squareness Ratio SQ)

By using a vibrating sample magnetometer (VSM-P7, manufactured by Toei Industry Co., Ltd.), the perpendicular squareness ratio SQ was measured by applying an external magnetic field in the direction perpendicular to the magnetic layer surface of the magnetic tape, that is, in the thickness direction of the magnetic tape. The measurement conditions were set as follows: temperature: 23° C. ± 1° C., maximum external magnetic field: 1194 kA/m (15 kOe), and scanning speed: 4.8 kA/m/sec (60 Oe/sec). A magnetization curve as a magnetic recording medium was obtained by subtracting the magnetization of a sample probe of the vibrating sample magnetometer as background noise, and the perpendicular squareness ratio SQ was obtained from the magnetization curve.

The theoretical maximum value of the squareness ratio SQ is 1.00. In the case of a magnetic powder in which the perpendicular squareness ratio SQ of a magnetic tape determined under the above conditions is 0.67 or more, good SNR can be achieved in a magnetic recording medium required to have a high recording density, and it is evaluated to have performance that can meet the future severe needs due to high-density recording.

The test powder of this example had an Sr/(Sr+Ba) molar ratio of 0.041, and the perpendicular squareness ratio SQ of the magnetic tape using the test powder was 0.68. The results are shown in Table 1.

### Example 2

A hexagonal barium ferrite magnetic powder having an Sr/(Sr+Ba) molar ratio of 0.059 was produced in the same manner as in Example 1 according to the raw material composition and the production conditions shown in Table 1. A magnetic tape was produced under the same conditions as in Example 1 except that this powder was used as the test powder, and the magnetic properties were examined. As a result, the perpendicular squareness ratio SQ was 0.69. The results are shown in Table 1.

### Example 3

A hexagonal barium ferrite magnetic powder having an Sr/(Sr+Ba) molar ratio of 0.083 was produced in the same manner as in Example 1 according to the raw material composition and the production conditions shown in Table 1. A magnetic tape was produced under the same conditions as in Example 1 except that this powder was used as the test powder, and the magnetic properties were examined. As a result, the perpendicular squareness ratio SQ was 0.69. The results are shown in Table 1.

### Example 4

A hexagonal barium ferrite magnetic powder having an Sr/ (Sr+Ba) molar ratio of 0.093 was produced in the same manner as in Example 1 according to the raw material composition and the production conditions shown in Table 1. A magnetic tape was produced under the same conditions as in Example 1 except that this powder was used as the test powder, and the magnetic properties were examined. As a result, the perpendicular squareness ratio SQ was 0.70. The results are shown in Table 1.

### Example 5

A hexagonal barium ferrite magnetic powder having an Sr/ (Sr+Ba) molar ratio of 0.132 was produced in the same manner as in Example 1 according to the raw material composition and the production conditions shown in Table 1. A magnetic tape was produced under the same conditions as in Example 1 except that this powder was used as the test powder, and the magnetic properties were examined. As a result, the perpendicular squareness ratio SQ was 0.71. The results are shown in Table 1.

### Example 6

A hexagonal barium ferrite magnetic powder having an Sr/(Sr+Ba) molar ratio of 0.260 was produced in the same manner as in Example 1 according to the raw material composition and the production conditions shown in Table 2. A magnetic tape was produced under the same conditions as in Example 1 except that this powder was used as the test powder, and the magnetic properties were examined. As a result, the perpendicular squareness ratio SQ was 0.69. The results are shown in Table 2.

The test powder of this example has a high Sr/(Sr+Ba) molar ratio exceeding 0.15, but because it was produced by the above-mentioned production method of pattern 2 going through the preliminary heat treatment, a high perpendicular squareness ratio SQ of 0.67 or more could be maintained. The results are shown in Table 2.

### Example 7

A hexagonal barium ferrite magnetic powder having an Sr/ (Sr+Ba) molar ratio of 0.086 was produced by the above-mentioned production method of pattern 1 (conventional process), in which the preliminary heat treatment is not performed, according to the raw material composition and the production conditions shown in Table 2. The hexagonal barium ferrite magnetic powder was produced in the same manner as in Example 1 except that the process of pattern 2 was changed to pattern 1, and the magnetic powder was used as the test powder. A magnetic tape was produced under the same conditions as in Example 1 using this test powder, and the magnetic properties were examined. As a result, the perpendicular squareness ratio SQ was 0.67. The results are shown in Table 2.

### Comparative Example 1

A hexagonal barium ferrite magnetic powder was produced without adding Sr by the above-mentioned production method of pattern 1 (conventional process), in which the preliminary heat treatment is not performed, according to the raw material composition and the production conditions shown in Table 2. A small amount of Sr was detected as an unavoidable impurity in the analysis, and the Sr/(Sr+Ba) molar ratio was 0.002. The hexagonal barium ferrite magnetic powder was produced in the same manner as in Example 1 except that the process of pattern 2 was changed to pattern 1, and the magnetic powder was used as the test powder. A magnetic tape was produced under the same conditions as in Example 1 using this test powder, and the magnetic properties were examined. As a result, the perpendicular squareness ratio SQ was 0.66. The results are shown in Table 2.

### Comparative Example 2

A hexagonal barium ferrite magnetic powder having an Sr/ (Sr+Ba) molar ratio of 0.272 was produced by the above-mentioned production method of pattern 1 (conventional process), in which the preliminary heat treatment is not performed, according to the raw material composition and the production conditions shown in Table 2. The hexagonal barium ferrite magnetic powder was produced in the same manner as in Example 1 except that the process of pattern 2 was changed to pattern 1, and the magnetic powder was used as the test powder. A magnetic tape was produced under the same conditions as in Example 1 using this test powder, and the magnetic properties were examined. As a result, the perpendicular squareness ratio SQ was 0.65. The results are shown in Table 2.

In the following Examples 8 to 10, examples in which the Dx volume was adjusted within a range greater than 1,800 nm³ and 2,000 nm³ or less are disclosed.

### Example 8

A hexagonal barium ferrite magnetic powder having an Sr/(Sr+Ba) molar ratio of 0.046 and a Dx volume of 1,860 nm³ was produced in the same manner as in Example 1 according to the raw material composition and the production conditions shown in Table 3. A magnetic tape was produced under the same conditions as in Example 1 except that this powder was used as the test powder, and the magnetic properties were examined. As a result, the perpendicular squareness ratio SQ was 0.73. The results are shown in Table 3.

### Example 9

A hexagonal barium ferrite magnetic powder having an Sr/(Sr+Ba) molar ratio of 0.092 and a Dx volume of 1,870 nm³ was produced in the same manner as in Example 1 according to the raw material composition and the production conditions shown in Table 3. A magnetic tape was produced under the same conditions as in Example 1 except that this powder was used as the test powder, and the magnetic properties were examined. As a result, the perpendicular squareness ratio SQ was 0.73. The results are shown in Table 3.

### Example 10

A hexagonal barium ferrite magnetic powder having an Sr/(Sr+Ba) molar ratio of 0.144 and a Dx volume of 1,955 nm³ was produced in the same manner as in Example 1 according to the raw material composition and the production conditions shown in Table 3. A magnetic tape was produced under the same conditions as in Example 1 except that this powder was used as the test powder, and the magnetic properties were examined. As a result, the perpendicular squareness ratio SQ was 0.74. The results are shown in Table 3.

TABLE 1

| | | Example 1 | Example 2 | Example 3 | Example 4 | Example 5 |
|---|---|---|---|---|---|---|
| Raw material composition (g) | Fe₂O₃ | 934.4 | 939.7 | 945.0 | 950.3 | 955.7 |
| | BaCO₃ | 1432.8 | 1360.8 | 1287.9 | 1214.3 | 1139.8 |
| | SrCO₃ | 119.1 | 179.7 | 240.9 | 302.9 | 365.5 |
| | H₃BO₃ | 774.8 | 779.1 | 783.5 | 787.9 | 792.4 |
| | CoO | 8.8 | 8.8 | 8.9 | 8.9 | 9.0 |
| | TiO₂ | 18.7 | 18.8 | 18.9 | 19.0 | 19.1 |
| | Bi₂O₃ | 108.0 | 108.6 | 109.2 | 109.8 | 110.5 |
| | Nd₂O₃ | 140.4 | 141.2 | 142.0 | 142.8 | 143.6 |
| | Al(OH) ₃ | 63.0 | 63.4 | 63.7 | 64.1 | 64.4 |
| Preliminary heat treatment | Temperature (°C) | 530 | 530 | 530 | 530 | 530 |
| | Time (h) | 72 | 72 | 72 | 72 | 72 |
| Crystallization heat treatment temperature (^{O}C) | | 630 | 626 | 630 | 628 | 630 |
| Acid washing | Temperature (°C) | 60 | 60 | 60 | 60 | 60 |
| | Time (h) | 1 | 1 | 1 | 1 | 1 |
| | Acetic acid concentration (mass%) | 10 | 10 | 10 | 10 | 10 |
| Molar ratio in magnetic powder | Ba/(Fe+Co+Ti) | 0.075 | 0.073 | 0.069 | 0.069 | 0.066 |
| | Sr/(Ba+Sr) | 0.041 | 0.059 | 0.083 | 0.093 | 0.132 |
| | Co/Fe | 0.008 | 0.009 | 0.009 | 0.009 | 0.009 |
| | Ti/Fe | 0.020 | 0.020 | 0.020 | 0.021 | 0.021 |
| | Bi/Fe | 0.034 | 0.034 | 0.033 | 0.035 | 0.035 |
| | Nd/Fe | 0.004 | 0.004 | 0.004 | 0.004 | 0.004 |
| | Al/Fe | 0.047 | 0.047 | 0.044 | 0.045 | 0.047 |
| Magnetic powder properties | Hc (kA/m) | 173 | 177 | 185 | 185 | 204 |
| | σs (Am²/kg) | 41 | 42 | 42 | 42 | 42 |
| | SQ | 0.51 | 0.51 | 0.52 | 0.52 | 0.53 |
| | BET (m²/g) | 107 | 109 | 103 | 107 | 103 |
| | Vact (nm3) | 1720 | 1750 | 1870 | 1780 | 1950 |
| | Ku (MJ/m³) | 0.139 | 0.140 | 0.141 | 0.143 | 0.146 |
| | Dx volume (nm³) | 1575 | 1665 | 1575 | 1635 | 1705 |
| | Dx ratio | 2.7 | 2.7 | 2.7 | 2.7 | 2.6 |
| | Right side value of formula (2) [*1] | 0.134 | 0.136 | 0.138 | 0.139 | 0.143 |
| Medium property | Perpendicular squareness ratio SQ | 0.68 | 0.69 | 0.69 | 0.70 | 0.71 |

*1: 0.1 × [Sr/(Ba+Sr) molar ratio] + 0.13

TABLE 2

| | | Example 6 | Example 7 | Comparative Example 1 | Comparative Example 2 |
|---|---|---|---|---|---|
| Raw material composition (g) | Fe₂O₃ | 978.0 | 945.0 | 925.9 | 978.0 |
| | BaCO₃ | 833.1 | 1287.9 | 1577.6 | 833.1 |
| | SrCO₃ | 623.4 | 240.9 | 0.0 | 623.4 |
| | H₃BO₃ | 810.9 | 783.5 | 760.6 | 810.9 |
| | CoO | 9.2 | 8.9 | 8.7 | 9.2 |
| | TiO₂ | 19.6 | 18.9 | 18.5 | 19.6 |
| | Bi₂O₃ | 113.0 | 109.2 | 107.0 | 113.0 |
| | Nd₂O₃ | 146.9 | 142.0 | 139.1 | 146.9 |
| | Al(OH) ₃ | 65.9 | 63.7 | 62.4 | 65.9 |
| Preliminary heat treatment | Temperature (°C) | 550 | - | - | - |
| | Time (h) | 72 | - | - | - |
| Crystallization heat treatment temperature (°C) | | 640 | 614 | 618 | 620 |
| Acid washing | Temperature (°C) | 60 | 60 | 60 | 60 |
| | Time (h) | 1 | 1 | 1 | 1 |
| | Acetic acid concentration (mass%) | 10 | 10 | 10 | 10 |
| Molar ratio in magnetic powder | Ba/(Fe+Co+Ti) | 0.056 | 0.063 | 0.075 | 0.052 |
| | Sr/(Ba+Sr) | 0.260 | 0.086 | 0.002 | 0.272 |
| | Co/Fe | 0.009 | 0.009 | 0.009 | 0.009 |
| | Ti/Fe | 0.019 | 0.021 | 0.020 | 0.020 |
| | Bi/Fe | 0.036 | 0.037 | 0.034 | 0.037 |
| | Nd/Fe | 0.009 | 0.004 | 0.004 | 0.009 |
| | Al/Fe | 0.041 | 0.038 | 0.041 | 0.041 |
| Magnetic powder properties | Hc (kA/m) | 224 | 166 | 148 | 210 |
| | σs (Am2/kg) | 42 | 42 | 41 | 41 |
| | SQ | 0.53 | 0.50 | 0.50 | 0.52 |
| | BET (m²/g) | 91 | 112 | 112 | 96 |
| | Vact (nm3) | 1950 | 1890 | 1800 | 1960 |
| | Ku (MJ/m³) | 0.160 | 0.130 | 0.125 | 0.152 |
| | Dx volume (nm3) | 1665 | 1595 | 1557 | 1771 |
| | Dx ratio | 2.3 | 2.7 | 2.9 | 2.4 |
| | Right side value of formula (2) [*1] | 0.156 | 0.139 | 0.130 | 0.157 |
| Medium property | Perpendicular squareness ratio SQ | 0.69 | 0.67 | 0.66 | 0.65 |

*1: 0.1 × [Sr/(Ba+Sr) molar ratio] + 0.13

TABLE 3

| | | Example 8 | Example 9 | Example 10 |
|---|---|---|---|---|
| Raw material composition (9) | Fe₂O₃ | 934.4 | 945.0 | 955.7 |
| | BaCO₃ | 1432.8 | 1287.9 | 1139.8 |
| | SrCO₃ | 119.1 | ^{.}240.9 | 365.5 |
| | H₃BO₃ | 774.8 | 783.5 | 792.4 |
| | CoO | 8.8 | 8.9 | 9.0 |
| | TiO₂ | 18.7 | 18.9 | 19.1 |
| | Bi₂O₃ | 108.0 | 109.2 | 110.5 |
| | Nd₂O₃ | 140.4 | 142.0 | 143.6 |
| | Al(OH)₃ | 63.0 | 63.7 | 64.4 |
| Preliminary heat treatment | Temperature (°C) | 530 | 530 | 530 |
| | Time (h) | 72 | 72 | 72 |
| Crystallization heat treatment temperature (°C) | | 649 | 648 | 641 |
| Acid washing | Temperature (°C) | 60 | 60 | 60 |
| | Time (h) | 1 | 1 | 1 |
| | Acetic acid concentration (mass%) | 10 | 10 | 10 |
| Molar ratio in magnetic powder | Ba/(Fe+Co+Ti) | 0.078 | 0.072 | 0.068 |
| | Sr/(Ba+Sr) | 0.046 | 0.092 | 0.144 |
| | Co/Fe | 0.010 | 0.009 | 0.009 |
| | Ti/Fe | 0.021 | 0.020 | 0.021 |
| | Bi/Fe | 0.036 | 0.035 | 0.037 |
| | Nd/Fe | 0.004 | 0.004 | 0.005 |
| | Al/Fe | 0.055 | 0.051 | 0.049 |
| Magnetic powder properties | Hc (kA/m) | 208 | 217 | 224 |
| | σs (Am²/kg) | 42 | 42 | 43 |
| | SQ | 0.53 | 0.53 | 0.54 |
| | BET (m²/g) | 98 | 95 | 95 |
| | Vact (nm3) | 2010 | 1990 | 2070 |
| | Ku (MJ/M³) | 0.146 | 0.151 | 0.152 |
| | Dx volume (nm³) | 1860 | 1870 | 1955 |
| | Dx ratio | 2.7 | 2.5 | 2.6 |
| | Right side value of formula (2) [*1] | 0.135 | 0.139 | 0.144 |
| Medium property | Perpendicular squareness ratio SQ | 0.73 | 0.73 | 0.74 |

*1: 0.1 × [Sr/(Ba+Sr) molar ratio] + 0.13

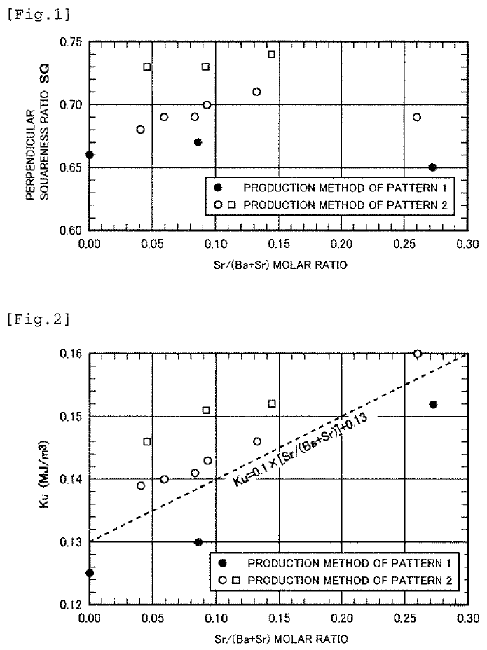

FIG. 1 shows the relationship between the Sr/(Sr+Ba) molar ratio of the hexagonal barium ferrite magnetic powder and the perpendicular squareness ratio SQ of the magnetic tape using the magnetic powder in each example. The open square plots are examples of Examples 8 to 10 in which the Dx volume is greater than 1,800 nm³ and 2,000 nm³ or less. It can be seen that the perpendicular squareness ratio SQ is improved by partially substituting Ba with a small amount of Sr. As the Sr/(Sr+Ba) molar ratio increases, the perpendicular squareness ratio SQ tends to decrease, however, when applying the hexagonal barium ferrite magnetic powder produced by the above-mentioned production method of pattern 2 going through the preliminary heat treatment, the effect of improving the perpendicular squareness ratio SQ (medium SQ improvement effect) increases, and also the range of the Sr/(Sr+Ba) molar ratio in which the medium SQ improvement effect is exhibited expands.

FIG. 2 shows the relationship between the Sr/(Sr+Ba) molar ratio of the hexagonal barium ferrite magnetic powder and the magnetocrystalline anisotropy constant Ku of the hexagonal barium ferrite magnetic powder in each example. The open square plots are examples of Examples 8 to 10 in which the Dx volume is greater than 1,800 nm³ and 2,000 nm³ or less. In FIG. 2, the line of the following formula (2) is indicated by a broken line. When compared with FIG. 1, it can be seen that those satisfying the following formula (2) have a particularly excellent medium SQ improvement effect. By applying the above-mentioned production method of pattern 2 goring through the preliminary heat treatment, a hexagonal barium ferrite magnetic powder that satisfies the following formula (2) is obtained.

$$\text{Ku} \geq \text{0} \text{.1} \times \left[\text{Sr} / \left(\text{Ba+Sr}\right) \text{molar ratio}\right] + 0.13 \qquad \text{(2)}$$

1. A magnetic powder for a magnetic recording medium, comprising magnetic particles in which Ba in hexagonal barium ferrite is partially substituted with Sr, wherein a Dx volume represented by the following formula (1) is 2,200 nm³ or less, and an Sr/(Ba+Sr) molar ratio is 0.01 to 0.15:
$$\text{Dx volume} \left({\text{nm}}^{3}\right) = \text{Dxc} \times Π \times {\left(\text{Dxa} / 2\right)}^{2} \qquad \text{(1)}$$
wherein Dxc is a crystallite diameter (nm) in a c-axis direction of a hexagonal ferrite crystal lattice, Dxa is a crystallite diameter (nm) in an a-axis direction of the same crystal lattice, and π is a circular constant.

2. A magnetic powder for a magnetic recording medium, comprising magnetic particles in which Ba in hexagonal barium ferrite is partially substituted with Sr, wherein a Dx volume represented by the following formula (1) is 2,200 nm³ or less, an Sr/(Ba+Sr) molar ratio is 0.01 to 0.30, and a relationship between a magnetocrystalline anisotropy constant Ku (MJ/m³) and the Sr/(Ba+Sr) molar ratio satisfies the following formula (2):
$$\text{Dx volume} \left({\text{nm}}^{3}\right) \text{= Dxc} \times Π \times {\left(\text{Dxa} / 2\right)}^{2} \qquad \text{(1)}$$
wherein Dxc is a crystallite diameter (nm) in a c-axis direction of a hexagonal ferrite crystal lattice, Dxa is a crystallite diameter (nm) in an a-axis direction of the same crystal lattice, and π is a circular constant, and
$$\text{Ku} \geq \text{0} \text{.1} \times \left[\text{Sr} / \left(\text{Ba+Sr}\right) \text{molar ratio}\right] \text{+ 0} \text{.13} \qquad \text{(2)}$$
.

3. The magnetic powder for a magnetic recording medium according to claim 2, wherein the Sr/(Ba+Sr) molar ratio is 0.01 to 0.15.

4. The magnetic powder for a magnetic recording medium according to claim 1, wherein Bi is contained such that a Bi/Fe molar ratio is within a range of 0.005 to 0.05.

5. A production method of the magnetic powder for a magnetic recording medium according to claim 1, comprising a step of crystallizing an amorphous body containing Sr as a constituent element of hexagonal barium ferrite by heating within a temperature range of 600 to 670° C.

6. A production method of the magnetic powder for a magnetic recording medium according to claim 2, comprising:
a step of obtaining an intermediate by holding an amorphous body containing Sr as a constituent element of hexagonal barium ferrite at a temperature of 500 to 570° C. for 10 hours or more; and
a step of crystallizing the intermediate by heating within a temperature range of 600 to 670° C.
